(19) United States
(12) Patent Application Publication
(10) Pub. No.: US 2019/0325404 A1
(43) Pub. Date: Oct. 24, 2019

(54) COMPUTER SYSTEM AND COMPUTER-IMPLEMENTED METHOD FOR PURCHASING AT LEAST ONE TICKET TO AN EVENT

(71) Applicant: MASTERCARD INTERNATIONAL INCORPORATED, Purchase, NY (US)

(72) Inventors: Sudhir GUPTA, Pune (IN); Rahul AGRAWAL, Pune (IN); Harsh PIPARSANIYA, Pune (IN)

(21) Appl. No.: 16/390,252

(22) Filed: Apr. 22, 2019

(30) Foreign Application Priority Data
Apr. 23, 2018 (SG) 10201803374S

(51) Int. Cl. G06Q 20/04; G06Q 20/38; G06Q 20/40; G10L 15/26; G06Q 10/02; G06Q 20/10

(52) U.S. Cl. CPC G06Q 20/045; G06Q 20/385; G06Q 20/108; G10L 15/265; G06Q 10/02; G06Q 20/4014

(57) ABSTRACT

A payment network server for processing a payment transaction for at least one ticket to an event is described. The server comprises a transaction module, an authorisation module and an access verification module. The transaction module is configured to: (i) receive a payment transaction request comprising at least a customer account identifier and a payment amount from a customer electronic device; and (ii) transmit a payment transaction response comprising at least the transaction identifier to the customer electronic device. The authorisation module is configured to transmit a request for authorisation to proceed with the payment transaction to an issuer server, where the request for authorisation comprises at least the customer account identifier and the payment amount, and where the payment amount is blocked in a customer account associated with the customer account identifier if the payment transaction is authorised. The access verification module is configured to: (i) transmit a speakeasy request comprising a request for a speakeasy password to the customer electronic device if the payment transaction is authorised; (ii) receive the speakeasy password from the customer electronic device; (iii) generate a transaction identifier which is associated with the payment transaction; and (iv) store the transaction identifier and the speakeasy password at a payment network database, where the speakeasy password is associated with the transaction identifier.

### CROSS-REFERENCE TO RELATED APPLICATIONS

This application claims priority to Singapore Patent Application No. 10201803374S filed on Apr. 23, 2018, which is hereby incorporated by reference in its entirety.

### FIELD OF THE INVENTION

The present invention relates to a computer system and computer-implemented method for purchasing at least one ticket to an event. In particular, the invention relates to improving convenience and security, and minimising wastage when purchasing at least one ticket to an event.

### BACKGROUND

Organising a group event requires a substantial amount of time and effort. To organize a group event, a sponsor for the event is typically required to consolidate and obtain confirmation on a total number of invitees attending the event before making payment for a correct number of tickets for the event. Even if the invitees have confirmed their attendance to the event, last minute changes or unforeseen circumstances may prevent them from attending the event, thereby resulting in wastage of unused tickets. Moreover, all invitees to the event may be required to be present at the same time before making entry to the event together (for example, in facilitating the handling of physical tickets by the sponsor or in making the entry together using a single electronic ticket). This involves further coordination by the sponsor to ensure that all invitees turn up at an event venue at the same time. Additionally, in a case where not all the invitees are present at the event venue together, the sponsor may be required to meet up with remaining invitees at a later time to allow them into the event, which presents much inconvenience to the sponsor.

In relation to making a group purchase, patent document US 2015/0051928 discloses a system and method to distribute electronic tickets to a plurality of recipients from a single purchase order so that individual recipients may access an event independently, while patent document US 2015/0081346 discloses a system and method for sharing event tickets where each ticket is associated with a unique code (e.g. a barcode representing the ticket) to be used by each invitee in gaining access to the event. Patent document US 2012/0078750 also discloses a system and method for group purchasing of tickets where funds from each member of the group may be held during booking of the tickets and are transferred only if confirmation to process the ticket purchase is made or if everyone in the group registers their details prior to the event.

However, none of these addresses at least the problem of wastage of tickets in the situation where an invitee does not attend the event. Moreover, none of the documents provides a secure way of ensuring utilization of the tickets by the intended recipient once the tickets have been distributed.

It is therefore an aim of the present invention to provide a computer system and computer-implemented method to improve convenience and security, and to minimise wastage of tickets for entry by a group of invitees to a ticketed event.

### SUMMARY OF THE INVENTION

In accordance with a first aspect of the present invention, there is provided a payment network server for processing a payment transaction for at least one ticket to an event. The payment network server comprising:
a transaction module configured to:
   receive, from a customer electronic device, a payment transaction request comprising at least a customer account identifier and a payment amount; and
   transmit, to the customer electronic device, a payment transaction response comprising at least the transaction identifier; and
an authorisation module configured to:
   transmit, to an issuer server, a request for authorisation to proceed with the payment transaction, wherein the request for authorisation comprises at least the customer account identifier and the payment amount, and wherein the payment amount is blocked in a customer account associated with the customer account identifier if the payment transaction is authorised; and
   receive, from the issuer server, an authorisation response indicating if the payment transaction is authorised or refused; and
an access verification module configured to:
   transmit, to the customer electronic device, a speakeasy request comprising a request for a speakeasy password if the payment transaction is authorised;
   receive, from the customer electronic device, a speakeasy response comprising the speakeasy password;
   generate a transaction identifier, the transaction identifier being associated with the payment transaction; and
   store, using a payment network database, the transaction identifier and the speakeasy password, wherein the speakeasy password is associated with the transaction identifier.

Embodiments of the invention therefore provide a payment network server that can be used for processing a payment transaction for at least one ticket to an event. In particular, the payment network server is configured to: (i) transmit, to an issuer server, a request for authorisation to proceed with the payment transaction and to block a payment amount in a customer account if the payment transaction is authorised; and (ii) request, from a customer associated with the payment transaction, a speakeasy password which can be subsequently used for utilising the at least one ticket at the event. Portions of the blocked payment amount may be transferred to a merchant selling the at least one ticket as each of the at least one ticket is used. This advantageously provides a new way for the customer to secure at least one ticket to an event without making full payment upfront (e.g. the payment amount for the at least one ticket is blocked and is only transferred upon utilization of the at least one ticket). Use of the speakeasy password in utilising the at least one ticket also provides a secured method to ensure that the at least one ticket is used by a rightful person. The combination of these features thereby improves customer experience in purchasing ticket(s) to an event and minimises wastage of unused ticket(s).

In addition, embodiments of the invention may advantageously use present infrastructures so that minimal costs will be incurred to implement the above. The primary set-up required is to store information related to transaction identifiers and their associated speakeasy passwords. This can be easily implemented using existing memory storages, servers and/or databases.

The server may comprise a ticket utilisation module configured to:
receive, from an invitee electronic device via a merchant server, a ticket utilisation request comprising at least the transaction identifier;
transmit, to the invitee electronic device, a speakeasy confirmation request comprising a request for a speakeasy password input;
receive, from the invitee electronic device, a speakeasy confirmation response comprising at least the speakeasy password input;
verify, using the payment network database, the speakeasy password input, the speakeasy password input is verified if the speakeasy password input matches the speakeasy password associated with the transaction identifier; and
transmit, to the merchant server, a ticket utilisation response indicating if utilisation of the ticket is approved or refused, the utilisation of the ticket is approved if the speakeasy password input is verified.

When the ticket is utilised by the invitee, the transaction module may be configured to:
transmit, to the issuer server, a fund transfer request to transfer at least a portion of the payment amount for the payment transaction, the fund transfer request comprising at least the transaction identifier and a transfer amount, the transfer amount being associated with at least a cost of the ticket used by the invitee to participate in the event; and
receive, from the issuer server, a fund transfer response indicating whether the fund transfer request is approved or refused.

When the ticket is utilised by the invitee, the transaction module may be configured to:
receive, from the merchant server, a fund transfer request comprising a request to transfer at least a portion of the payment amount for the payment transaction, the fund transfer request comprising at least the transaction identifier and a transfer amount, the transfer amount being associated with at least a cost of the ticket used by the invitee to participate in the event; and
transmit, to the issuer server, the fund transfer request to transfer at least the portion of the payment amount; and
receive, from the issuer server, a fund transfer response indicating whether the fund transfer request is approved or refused.

The server may comprise a distribution module configured to:
receive, from the customer electronic device, invitee details associated with at least one invitee invited to participate in the event, the invitee details comprising at least an invitee contact; and
transmit, to each invitee electronic device associated with the at least one invitee using the invitee contact, the transaction identifier and the speakeasy password.

In accordance with a second aspect of the present invention, there is provided a computer-implemented method for processing a payment transaction for at least one ticket to an event, the method comprising:
receiving, from a customer electronic device, a payment transaction request comprising at least a customer account identifier and a payment amount;
transmitting, to an issuer server, a request for authorisation to proceed with the payment transaction, wherein the request for authorisation comprises at least the customer account identifier and the payment amount, and wherein the payment amount is blocked in a customer account associated with the customer account identifier if the payment transaction is authorised;
receiving, from the issuer server, an authorisation response indicating if the payment transaction is authorised or refused;
transmitting, to the customer electronic device, a speakeasy request comprising a request for a speakeasy password if the payment transaction is authorised;
receiving, from the customer electronic device, a speakeasy response comprising the speakeasy password;
generating a transaction identifier, the transaction identifier being associated with the payment transaction;
storing, using a payment network database, the transaction identifier and the speakeasy password, wherein the speakeasy password is associated with the transaction identifier; and
transmitting, to the customer electronic device, a payment transaction response comprising at least the transaction identifier.

The method may comprise:
receiving, from an invitee electronic device via a merchant server, a ticket utilisation request comprising at least the transaction identifier;
transmitting, to the invitee electronic device, a speakeasy confirmation request comprising a request for a speakeasy password input;
receiving, from the invitee electronic device, a speakeasy confirmation response comprising at least the speakeasy password input;
verifying, using the payment network database, the speakeasy password input, the speakeasy password input is verified if the speakeasy password input matches the speakeasy password associated with the transaction identifier; and
transmitting, to the merchant server, a ticket utilisation response indicating if utilisation of the ticket is approved or refused, the utilisation of the ticket is approved if the speakeasy password input is verified.

When the ticket is utilised by the invitee, the method may comprise:
transmitting, to the issuer server, a fund transfer request to transfer at least a portion of the payment amount for the payment transaction, the fund transfer request comprising at least the transaction identifier and a transfer amount, the transfer amount being associated with at least a cost of the ticket used by the invitee to participate in the event; and
receiving, from the issuer server, a fund transfer response indicating whether fund transfer request is approved or refused.

Where the ticket is utilised by the invitee, the method may comprise:
receiving, from the merchant server, a fund transfer request comprising a request to transfer at least a portion of the payment amount for the payment transaction, the fund transfer request comprising at least the transaction identifier and a transfer amount, the transfer amount being associated with at least a cost of the ticket used by the invitee to participate in the event;
transmitting, to the issuer server, the fund transfer request to transfer at least the portion of the payment amount; and
receiving, from the issuer server, a fund transfer response indicating whether the fund transfer request is approved or refused.

The method may comprise:
receiving, from the customer electronic device, invitee details associated with at least one invitee invited to participate in the event, the invitee details comprising at least an invitee contact; and
transmitting, to each invitee electronic device associated with the at least one invitee using the invitee contact, the transaction identifier and the speakeasy password.

The invitee contact may be one of a mobile number or an electronic mail address.

The speakeasy password may comprises a string of numbers, words, symbols or alphanumeric characters.

The speakeasy password received via the customer electronic device may be in the form of a speech.

The transaction identifier may be one of the following: a Quick Response (QR) code, a barcode, an EZcode, a high capacity color barcode, a ShotCode, a MaxiCode, a GTIN12 code, a GTIN-13 code, Aztec code, a name and a mobile number.

In accordance with a third aspect of the present invention, a non-transitory computer-readable medium having stored thereon program instructions for causing at least one processor to perform the preceding method.

The present invention aims to provide a new and useful computer system and computer-implemented method for processing a payment transaction for at least one ticket to an event to improve convenience and security, and to minimise wastage of tickets for entry by a group of invitees to a ticketed event.

### BRIEF DESCRIPTION OF THE DRAWINGS

Non-limiting embodiments of the invention will now be described for the sake of example only, with reference to the following drawings in which:

FIG. 1 shows a computer system for processing a payment transaction for at least one ticket to an event in accordance with an embodiment of the invention;

FIG. 2 shows steps of a method for processing a payment transaction for at least one ticket to an event in accordance with an embodiment of the invention;

FIG. 3 shows steps of a method for distributing at least one ticket to an event processed in a payment transaction in accordance with an embodiment of the invention;

FIG. 4 shows steps of a method for utilising at least one ticket to an event in accordance with an embodiment of the invention;

FIG. 5 shows steps of a method for processing payment for at least one ticket to an event in accordance with an embodiment of the invention;

FIG. 6 shows steps of a method for processing payment for at least one ticket to an event in accordance with an embodiment of the invention;

FIG. 7 shows steps of a method for processing a payment transaction for at least one ticket to an event in accordance with an embodiment of the invention;

FIG. 8 shows steps of a method for utilising at least one ticket to an event in accordance with an embodiment of the invention;

FIG. 9 shows schematically a functional structure of a payment network server which may be used in the computer system shown in FIG. 1 to implement a method in accordance with an embodiment of the invention; and

FIG. 10 shows schematically a hardware structure of a server which may be used in the computer system of FIG. 1 to implement a method in accordance with an embodiment of the invention.

### DETAILED DESCRIPTION OF THE EMBODIMENT

As used in this document, the term “ticket” refers to any form of voucher or coupon or the like which permits a holder of the ticket to enter or take part in an event. A ticket may be in a physical form (e.g. paper) or an electronic form (e.g. electronic code), and it may be purchased or reserved in advance of the event, or it may be purchased during the event.

The term “event” refers to any planned social occasion. An event can be private or public. An event referred to in this invention typically requires a ticket (paid or free) for entry.

Note that the term “account” refers to any financial account (e.g. a current account, a saving account, a trading account etc.) or any account associated with a credit card, a debit card, a prepaid card, a charge card, a membership card, a promotional card, a frequent flyer card, an identification card, a prepaid card, a gift card, and/or any other payment device that may hold payment account information, such as mobile phones, Smartphones, personal digital assistants (PDAs), key fobs, transponder devices, NFC-enabled devices, and/or computers.

Note that the term “institution” is used here in a sense which is not necessarily limited to organizations which are legally constituted as banks, since in some jurisdictions other organizations may be permitted to maintain financial accounts such as a payment card account. An institution may be one of the following: a bank, a financial technology company, a telecommunication company or a financial institution.

As used in this application, the terms “component,” “module,” “system,” “apparatus,” “interface,” or the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component or a module. One or more components/modules may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

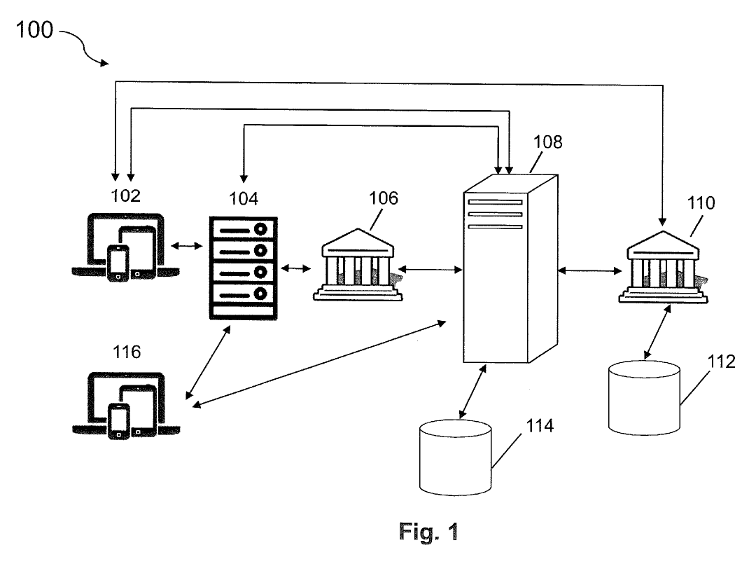

FIG. 1 shows a computer system 100 for processing a payment transaction for at least one ticket to an event in accordance with an embodiment of the invention. The computer system 100 comprises a payment network server 108 which facilitates a payment transaction between a customer and a merchant. The payment network server 108 is a server associated with a payment network such as the Banknet payment network operated by MasterCard®. As shown in FIG. 1, the payment network server 108 is in communication with an acquirer server 106 and an issuer server 110. The acquirer server 106 is operated by an acquirer institution at which the merchant maintains a merchant account to receive funds. The issuer server 110 is associated with an issuer institution which maintains at least a customer account which can be used for payment in payment transactions (e.g. card-not-present payment transactions using an e-commerce website or physical in-store payment transactions at a point-of-sale (POS) terminal). The computer system 100 further comprises a customer electronic device 102 and a merchant server 104. The customer electronic device 102 is any electronic device which enables the customer to purchase product(s) online through e-commerce sites or at a POS terminal associated with a merchant. The customer electronic device 102 may be a mobile phone, a laptop/notebook, a desktop, a tablet, a personal digital assistant (PDA), a key fob, a transponder device, a NFC-enabled device, and/or a computer. The merchant server 104 may be associated with a merchant apparatus or a POS terminal in a merchant's shop or an e-commerce site on which payment transactions can be initiated. Moreover, an issuer database 112 is operationally connected to the issuer server 110. The issuer database 112 serves at least to store data related to a customer account associated with the customer which can be used for payment of at least one ticket to an event. The data associated with the customer account may comprise a customer account identifier (e.g. a customer account number), details associated with the customer (a customer name, a customer's date of birth etc.) and details associated with a status of the customer account (e.g. an available balance, transaction history etc.). In some embodiments, a payment network database 114 may be operationally connected to the payment network server 108. The payment network database 114 may store data related to at least a payment transaction associated with the customer (e.g. a transaction identifier, a payment amount etc.). The payment network database 114 may store at least a speakeasy password associated with a payment transaction for at least one ticket to an event. Although the issuer database 112 and the payment network database 114 are shown as external databases in FIG. 1, these databases 112, 114 may also form part of the issuer server 110 and the payment network server 108 respectively.

The computer system 100 may comprise an invitee electronic device 116. The invitee electronic device 116 is associated with a guest (e.g. a relative or friend of the customer) invited by the customer to attend the event. The invitee electronic device 116 may be a mobile phone, a laptop/notebook, a desktop, a tablet, a personal digital assistant (PDA), a key fob, a transponder device, a NFC-enabled device, and/or a computer or any device which is able to receive/transmit data from the merchant server 104 and/or the payment network server 108 so as to accept an invitation by the customer to take part in the event.

The present invention aims to build upon present infrastructures for processing a payment transaction for at least one ticket to an event. In particular, the present invention involves registration of a speakeasy password for each payment transaction associated with at least one ticket to an event, where the speakeasy password may be subsequently requested to verify an identity of a holder of the at least one ticket when he/she wishes to utilise the ticket for the event. Moreover, payment for the at least one ticket is blocked by the issuer server 110 at a time of purchase but is only transferred upon utilisation of the at least one ticket. This advantageously provides a new way for the customer to secure at least one ticket to an event without making full payment upfront. Moreover, use of the speakeasy password provides a secured method for utilising the at least one ticket at the event.

In order to achieve the above, the payment network server 108 is configured to: (i) receive a payment transaction request comprising at least a customer account identifier and a payment amount from the customer electronic device 102; (ii) transmit a request for authorisation to proceed with the payment transaction to the issuer server 110, where the request for authorisation comprises at least the customer account number and the payment amount and where the payment amount is withheld in a customer account associated with the customer account identifier if the payment transaction is authorised; (iii) receive an authorisation response indicating if the payment transaction is authorised or refused from the issuer server 110; (iv) transmit a speakeasy request comprising a request for a speakeasy password if the payment transaction is authorised to the customer electronic device 102; (v) receive the speakeasy password from the customer electronic device 102; (vi) generate a transaction identifier associated with the payment transaction; (vii) store the transaction identifier and the speakeasy password at the payment network database 114 where the speakeasy password is associated with the transaction identifier; and (viii) transmit a payment transaction response comprising at least the transaction identifier to the customer electronic device 102.

Typically, in order to process a payment transaction (either associated with a POS terminal or a merchant e-commerce website), a payment transaction request is transmitted from the merchant server 104 to the payment network server 108 (directly or via the acquirer server 106). The payment transaction request may comprise at least a customer account identifier and a payment amount. The customer account identifier is associated with an account of the customer and may comprise an account number, a name of the customer or any identifier that can uniquely associates the customer account with the customer. The payment amount is associated with a monetary amount which the customer has agreed to pay the merchant for goods and/or services associated with the payment transaction (e.g. at least one ticket to an event). Typically where a payment card is used for the payment transaction, the customer account identifier is a payment card number. Other information may also be included in the payment transaction request, for example, a card verification coded (CVC), a name of the cardholder, an expiry date of the payment card etc. Upon receiving the payment transaction request from the merchant server 104, the payment network server 108 is typically required to request authorisation from the issuer server 110 in order to proceed with the payment transaction. The request for authorisation comprises at least the customer account identifier and the payment amount. Typically, the request for authorisation may comprise the CVC and the expiry date of the payment card. Conventionally, in order to authorise the payment transaction, the issuer server 110 is configured to (i) verify the CVC code and/or (ii) the expiry date of the payment card etc. The issuer server 110 may also be configured to check an available balance of the customer account associated with the customer account identifier to determine if the available balance is more than the payment amount (or conversely, if the available balance is less than the payment amount). The available balance may comprise any overdraft balance available to the customer account. The issuer server 110 then authorises the payment transaction if the relevant details are verified and that the available balance is equal to or more than the payment amount. The payment transaction is then processed and the payment amount deducted from the customer account during a settlement process after the payment transaction has been authorised.

In embodiments of the present invention, the issuer server 110 is configured to block (i.e. pre-authorise) the payment amount in the customer account if the payment transaction is authorised. However, at this point no funds are transferred. Moreover, upon receiving an authorisation response indicating if the payment transaction is authorised or refused, the payment network server 108 is configured to transmit a speakeasy request comprising a request for a speakeasy password to the customer electronic device 102 if the payment transaction is authorised. The customer may decide the speakeasy password and transmit the speakeasy password via the customer electronic device 102 to the payment network server 110. The speakeasy password may be entered into the customer electronic device 102 using a real or virtual keyboard, or may be spoken by the customer and received via an audio input of the customer electronic device 102. The speakeasy password is required for using the at least one ticket for the payment transaction at a later time (see below for more detail). The speakeasy password may comprise a string of numbers, words, symbols or alphanumeric characters. The speakeasy password may be a phrase such as “rose is red” or “I love New York” etc. The speakeasy password received by the payment network server 108 may be in the form of a speech. Upon receiving the speakeasy password from the customer, the payment network server 108 is configured to generate a transaction identifier, associate it with the speakeasy password and store the transaction identifier and the speakeasy password in the payment network database 114. The transaction identifier may be one of the following: a Quick Response (QR) code, a barcode, an EZcode, a high capacity color barcode, a ShotCode, a MaxiCode, a GTIN12 code, a GTIN-13 code, Aztec code, a name and a mobile number. In some embodiments, the transaction identifier may be generated by the payment network server 108 upon receiving the payment transaction request from the merchant server 104. In this case, the transaction identifier may be comprised in the request for authorisation to the issuer server 110 and may be stored in the payment network database 114 prior to requesting a speakeasy password from the customer via the customer electronic device 102. In either of these cases, upon receiving the speakeasy password and having generated and stored the transaction identifier and the speakeasy password, the payment network server 108 is configured to transmit a payment transaction response indicating if the payment transaction has been approved or refused to the customer electronic device 102. The payment transaction response comprises at least the transaction identifier associated with the payment transaction.

In some embodiments where the customer wishes to share one or more of the tickets reserved/purchased to an invitee/guest to invite him/her to participate in the event, the payment network server 108 is configured to receive invitee details associated with at least one invitee invited to participate in the event from the customer electronic device 102. The invitee details may comprise at least an invitee contact where the invitee contact may be one of a mobile number or an electronic mail address. The payment network server 108 may be configured to transmit the transaction identifier and the speakeasy password to each invitee electronic device 116 associated with the at least one invitee.

To utilise the at least one ticket at the event, the invitee may be required to reproduce the transaction identifier together with its associated speakeasy password at the event. To facilitate this, the payment network server 108 may be configured to (i) receive a ticket utilisation request comprising at least the transaction identifier; (ii) transmit a speakeasy confirmation request comprising a request for a speakeasy password input to the invitee electronic device 116; (iii) receive a speakeasy confirmation response comprising at least the speakeasy password input from the invitee electronic device 116; (iv) verify the speakeasy password input using the payment network database 114 where the speakeasy password input is verified if the speakeasy password input matches the speakeasy password associated with the transaction identifier; and (v) transmit a ticket utilisation response indicating if utilisation of the ticket is approved or refused to the merchant server 104, where the utilisation of the ticket is approved if the speakeasy password input is verified.

When the ticket has been utilised by the customer or the invitee, the issuer server 110 is instructed to transfer at least a portion of the payment amount associated with the cost of the utilised ticket for payment to the merchant. In some embodiments, the payment network server 108 is configured to transmit a request to transfer the portion of the payment amount to the issuer server 110 directly. In this case, the payment network server 108 may be configured to transmit a fund transfer request to transfer at least the portion of the payment amount for the payment transaction to the issuer server 110. The fund transfer request comprises at least the transaction identifier and a transfer amount, where the transfer amount is associated with at least a cost of the ticket used by the invitee to participate in the event. In some embodiments, the payment network server 108 transmits the request to transfer the portion of the payment amount upon request by the merchant server 104. In this case, the payment network server 108 is configured to receive the fund transfer request comprising a request to transfer at least a portion of the payment amount for the payment transaction from the merchant server 104, and to transmit the fund transfer request to transfer at least the portion of the payment amount for the payment transaction to the issuer server 110. In either of the cases described above, the payment network server 108 is configured to receive a fund transfer response indicating whether the fund transfer request is approved or refused from the issuer server 110. The fund transfer response may then be forwarded by the payment network server 108 to the merchant server 104.

A penalty may be associated with each ticket which is not utilised at the end of the event. If a penalty is incurred, the payment network server 108 may be configured to instruct the issuer server 110 to deduct a cancellation amount from the payment amount as penalty for the unused ticket(s) before releasing a remaining portion of the blocked payment amount associated with the unused ticket(s) to the customer account. The cancellation amount for each unused ticket may be determined by the merchant or the payment network server 108. This may be made known to the customer when he or she initiate the payment transaction to purchase the tickets for the event. In the case where the cancellation amount is determined by the payment network server 108, any merchant selling tickets to customers using the payment network abides to a similar cancellation policy. The cancellation amount for each unused ticket may be a portion of the cost of a ticket, and it may be a fixed amount or a percentage amount tie to a monetary value of the ticket. The payment network server 108 may be configured to tabulate a total number of unused ticket(s) at the end of the event and to calculate an unused balance amount to be transferred to the customer taking into account any penalty imposed for the unused ticket(s).

Although only one customer electronic device 102, one invitee electronic device 116 and only one merchant server 104 is shown in FIG. 1, a plurality of customer electronic devices 102, a plurality of invitee electronic devices 116 and a plurality of merchant servers 104 associated with respective e-commerce sites or POS terminals may also form part of the computer system 100. Similarly, a plurality of acquirer servers 106 and a plurality of issuer servers 110 may also be in communication with the payment network server 108 and form part of the computer system 100. A plurality of issuer databases 112 and/or payment network databases 114 associated with respective issuer servers 110 and payment network servers 108 respectively may also form part of the computer system 100.

Communication between the customer electronic device 102, servers and databases 112, 114 may take place via any type of system, for example, a virtual private system (VPN), the Internet, a local area and/or wide area system (LAN and/or WAN), and so on.

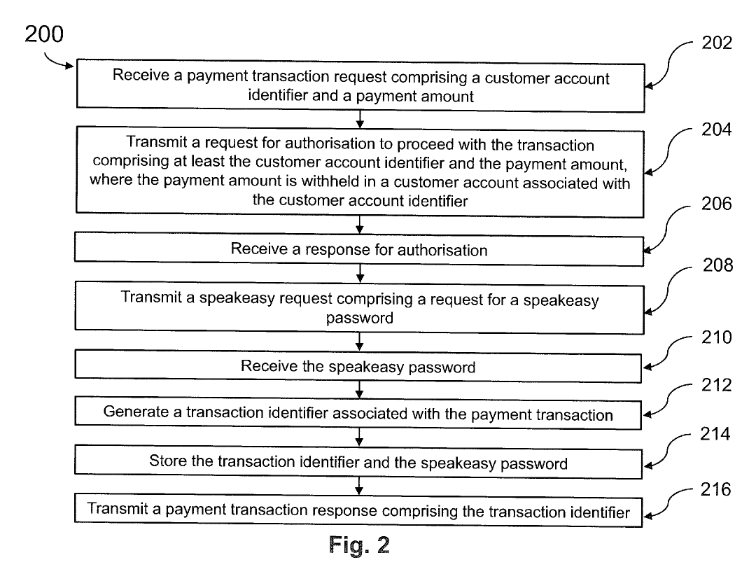

FIG. 2 shows steps of a method 200 for processing a payment transaction for at least one ticket to an event in accordance with an embodiment of the invention. The method 200 may be carried out using the payment network server 108 as shown in FIG. 1.

In a step 202, the payment network server 108 is configured to receive a payment transaction request comprising at least a customer account identifier and a payment amount from the customer electronic device 102. The payment transaction request may comprise a speakeasy identifier indicating that the payment transaction is associated with speakeasy.

In a step 204, the payment network server 108 is configured to transmit a request for authorisation to proceed with the payment transaction to the issuer server 110, where the request for authorisation comprises at least the customer account identifier and the payment amount. If the request for authorisation is approved, the issuer server 110 is configured to block the payment amount in the customer account associated with the customer account identifier. The blocked payment amount ensures that the customer account has sufficient funds to complete the payment transaction once the goods or services have been provided by the merchant (e.g. upon utilisation of the at least one ticket to the event).

In a step 206, the payment network server 108 is configured to receive an authorisation response indicating if the payment transaction is authorised or refused from the issuer server 110. The issuer server 110 may perform the conventional checks before authorising the payment transaction as discussed previously in relation to FIG. 1.

In a step 208, the payment network server 108 is configured to transmit a speakeasy request comprising a request for a speakeasy password to the customer electronic device 102 if the payment transaction is authorised. If the payment transaction is not authorised, the payment network server 108 may inform the customer (e.g. via the merchant server 104) of a failure to authorise the payment transaction and may request another form of payment if the customer wishes to continue processing the payment transaction.

In a step 210, the payment network server 108 is configured to receive a speakeasy response comprising the speakeasy password from the customer electronic device 102. In some embodiments, the speakeasy response also comprises customer contact details (e.g. mobile number or electronic mail (e-mail) addresses).

Once the speakeasy response has been received in the step 210, the payment network server 108 is configured to generate a transaction identifier associated with the payment transaction in a step 212. The transaction identifier may be one of the following: a Quick Response (QR) code, a barcode, an EZcode, a high capacity color barcode, a ShotCode, a MaxiCode, a GTIN12 code, a GTIN-13 code, Aztec code, a name and a mobile number.

Upon generating the transaction identifier, the payment network server 108 is configured to store the transaction identifier and the speakeasy password at the payment network database 114 in a step 214, where the speakeasy password is associated with the transaction identifier.

In a step 216, the payment network server 108 is configured to transmit a payment transaction response comprising at least the transaction identifier to the customer electronic device 102. The payment transaction response may indicate that the payment transaction has been completed and the payment amount has been blocked in the customer account.

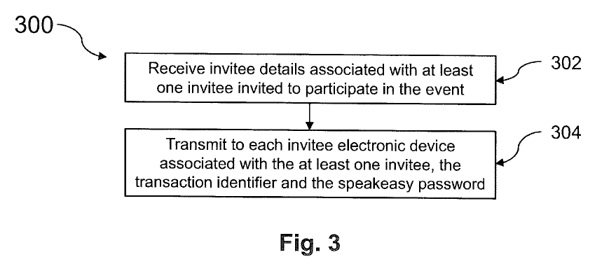

FIG. 3 shows steps of a method 300 for distributing at least one ticket to an event processed in a payment transaction in accordance with an embodiment of the invention. The method 300 may be performed at the end of the method 200 once the payment transaction has been authorised and processed. In some embodiments, the customer is prompted to input invitee details at the end of the step 216 when the customer received the payment transaction response.

In a step 302, the payment network server 108 is configured to receive invitee details associated with at least one invitee invited to participate in the event from the customer electronic device 102. The invitee details comprises at least an invitee contact where the invitee contact may be a mobile number or an electronic mail address associated with the invitee.

In a step 304, the payment network server 108 is configured to transmit, to each invitee electronic device associated with the at least one invitee using the invitee contact, the transaction identifier and the speakeasy password. The at least one invitee may therefore be provided with the transaction identifier and the speakeasy password for utilising the at least one ticket at the event.

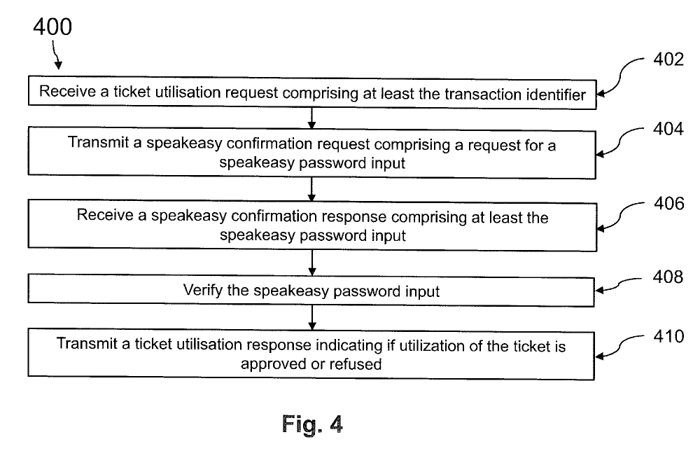

FIG. 4 shows steps of a method 400 for utilising at least one ticket to an event in accordance with an embodiment of the invention. The method 400 may be carried out at the payment network server 108 when an invitee wishes to utilise a ticket purchased by the customer in the payment transaction. It should be apparent to a skilled person in the art that the following method is equally applicable if the customer wishes to utilise the at least one ticket at the event.

In a step 402, the payment network server 108 is configured to receive, from the invitee electronic device 116 via the merchant server 104, a ticket utilisation request comprising at least the transaction identifier.

In a step 404, the payment network server 108 is configured to transmit a speakeasy confirmation request comprising a request for a speakeasy password input to the invitee electronic device 116. The request for the speakeasy password input serves to verify an identity of a ticket holder (i.e. to check if the ticket holder is the invitee or the customer) before a ticket associated with the payment transaction can be utilised.

In a step 406, the payment network server 108 is configured to receive a speakeasy confirmation response comprising at least the speakeasy password input from the invitee electronic device 116.

In a step 408, the payment network server 108 is configured to verify the speakeasy password input using the payment network database 114. The speakeasy password input is verified if it is determined that the speakeasy password input matches the speakeasy password associated with the transaction identifier.

In a step 410, the payment network server 108 is configured to transmit, to the merchant server 104, a ticket utilisation response indicating if utilisation of the ticket is approved or refused, the utilisation of the ticket is approved if the speakeasy password input is verified.

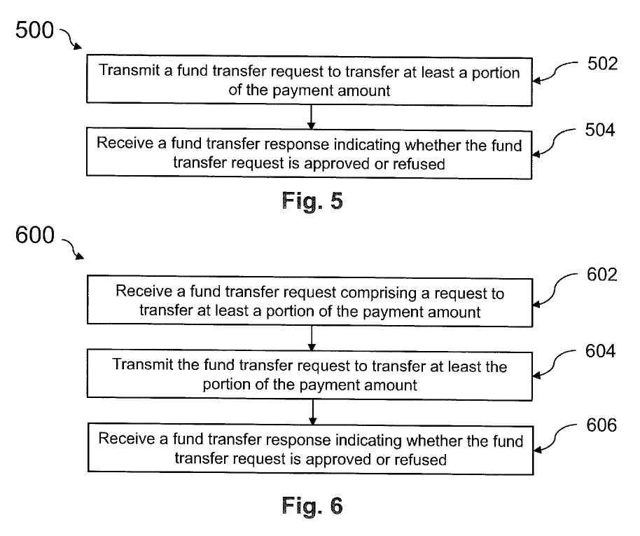

FIGS. 5 and 6 show two different embodiments for processing payment for at least one ticket to an event. FIG. 5 shows an embodiment where the payment network server 108 is configured to instruct the issuer server 110 directly, while FIG. 6 shows an embodiment where a request to transfer funds is received from the merchant server 104. In either embodiment, the payment may be processed as each of the at least one ticket is utilised at the event, or at the end of the event (i.e. after a total number of tickets utilised for the event is known).

Referring to FIG. 5, in a step 502, the payment network server 108 is configured to transmit, to the issuer server 110, a fund transfer request to transfer at least a portion of the payment amount for the payment transaction. The fund transfer request comprises at least the transaction identifier and a transfer amount where the transfer amount is associated with at least a cost of the ticket used by the invitee to participate in the event.

In a step 504, the payment network server 108 is configured to receive a fund transfer response indicating whether the fund transfer request is approved or refused.

Referring to FIG. 6, in a step 602, the payment network server 108 is configured to receive a fund transfer request comprising a request to transfer at least a portion of the payment amount for the payment transaction from the merchant server 104. The fund transfer request comprises at least the transaction identifier and a transfer amount, where the transfer amount is associated with at least a cost of the ticket used by the invitee or the customer to participate in the event.

In a step 604, the payment network server 108 is configured to transmit the fund transfer request to transfer at least the portion of the payment amount to the issuer server 110.

In a step 606, the payment network server 108 is configured to receive a fund transfer response indicating whether the fund transfer request is approved or refused.

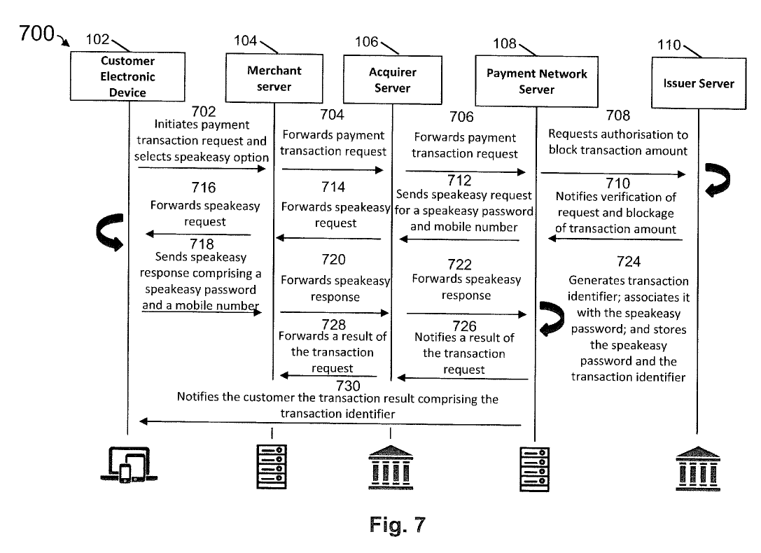

FIG. 7 illustrates an exemplary embodiment for processing a payment transaction for at least one ticket to an event. The customer may initiate the payment transaction at a merchant apparatus associated with a merchant server 104 in a retail location associated with a merchant. The merchant apparatus may be a self-service kiosk or a Point-of-Sale (POS) terminal. A payment transaction may also be initiated online via a merchant internet website associated with the merchant server 104.

The customer initiates a payment transaction using the customer electronic device 102 either at the merchant apparatus or the merchant website associated with the merchant server 104. In some embodiments, either at the merchant apparatus or the merchant website, the customer is provided with an option to proceed with initiating the payment transaction associated with speakeasy. The payment transaction request comprises at least a customer account identifier and a payment amount for the transaction and it may be provided to the merchant server 104 via the customer electronic device 102 in a step 702. In some embodiments where a payment card is used in processing the payment transaction request, the payment transaction request comprises a CVC code, a name of the cardholder and/or an expiry date of the payment card. In some embodiments, the payment transaction request comprises a speakeasy identifier indicating that the payment transaction is associated with speakeasy. The customer account identifier may be an account number or a payment card number. The payment amount is associated with costs of at least one ticket purchased for an event. The merchant server 104 then transmits the payment transaction request to the acquirer server 106 in a step 704 which in turn forwards the request to the payment network server 108 in a step 706.

After the payment transaction request is received in the step 706, the payment network server 108 is configured to transmit a request for authorisation to proceed with the transaction to the issuer server 110 in a step 708. The request for authorisation comprises at least the customer account identifier and the payment amount. The request of authorisation may comprise the speakeasy identifier to indicate that the payment transaction uses speakeasy and any payment amount authorised to be blocked in the customer account by the issuer server 110. In some embodiments, the request for authorisation may comprise the CVC and/or the expiry date of the payment card. In these cases, in order to authorise the payment transaction, the issuer server 110 may be configured to (i) verify the CVC code and/or (ii) determine if the expiry date of the payment card is still valid. The issuer server 110 may be configured to check an available balance of the customer account associated with the customer account identifier to determine if the available balance is more than the payment amount (or conversely, if the available balance is less than the payment amount). The available balance may comprise any overdraft balance available to the customer account. In some embodiments, if the relevant details are verified and/or the available balance is equal to or more than the payment amount, the issuer server 110 is configured to authorise the payment transaction and block the payment amount in the customer account.

Once the issuer server 110 has processed the request for authorisation, the issuer server 110 is configured to transmit an authorisation response to the payment network server 108 in a step 710. The authorisation response may indicate whether the payment transaction is authorised or refused, and if the payment transaction is authorised, that the payment amount is blocked in the customer account. If the payment transaction is authorised, the payment network server 108 is configured to transmit a speakeasy request comprising a request for a speakeasy password to the customer. The speakeasy request may also comprise a request for a customer mobile number. The speakeasy password may comprise a string of numbers, symbols or alphanumeric characters. The speakeasy request may be transmitted to the acquirer server 106 (e.g. in a step 712), which in turns forwards the speakeasy request to the merchant server 104 in a step 714. The merchant server 104 then transmits the speakeasy request to the customer electronic device 102 in a step 716.

In a step 718, the customer determines the speakeasy password and transmits a speakeasy response comprising the speakeasy password via the customer electronic device 102 to the merchant server 104. The speakeasy response may comprise a customer mobile number. The merchant server 104 forwards the speakeasy response to the acquirer server 106 in a step 720, which in turns forwards it to the payment network server 108 in a step 722. The speakeasy password received by the payment network server 108 may be in the form of a speech. Upon receiving the speakeasy response, the payment network server 108 is configured to generate a transaction identifier and associates the transaction identifier with the speakeasy password, and store the transaction identifier and the speakeasy password in the payment network database 114 in a step 724. The transaction identifier may be one of the following: a Quick Response (QR) code, a barcode, an EZcode, a high capacity color barcode, a ShotCode, a MaxiCode, a GTIN12 code, a GTIN-13 code, Aztec code, a name and a mobile number.

Once the transition identifier has been generated and associated with the speakeasy password in the step 724, the payment network server 108 is configured to transmit a payment transaction response indicating if the payment transaction has been approved or refused to the customer and/or the merchant server 104. The payment transaction response comprises at least the transaction identifier. In a step 726, the payment network server 108 is configured to transmit the payment transaction response to the acquirer server 106 which in turns forwards the payment transaction response to the merchant server 104 in a step 728. In a step 730, the payment network server 108 is configured to transmit the payment transaction response to the customer via the customer electronic device 102. This may be done using the customer mobile number received in the speakeasy response in the step 722. The steps of informing the customer and/or the merchant as shown in the above steps may be performed in parallel or one after the other. In some embodiments, the step 730 may not be performed. In this case, the customer may be informed of the payment transaction response by the merchant (e.g. at the merchant apparatus or POS terminal) via the merchant server 104.

In some embodiments (not shown in this figure) where the customer wishes to share one or more of the reserved/purchased tickets to an invitee/guest, the payment network server 108 is configured to receive invitee details associated with at least one invitee invited to participate in the event from the customer electronic device 102. The invitee details may comprise at least an invitee contact, the invitee contact may be one of a mobile number or an electronic mail address. The payment network server 108 may be configured to transmit the transaction identifier and the speakeasy password to each invitee electronic device 116 associated with the at least one invitee using the invitee contact.

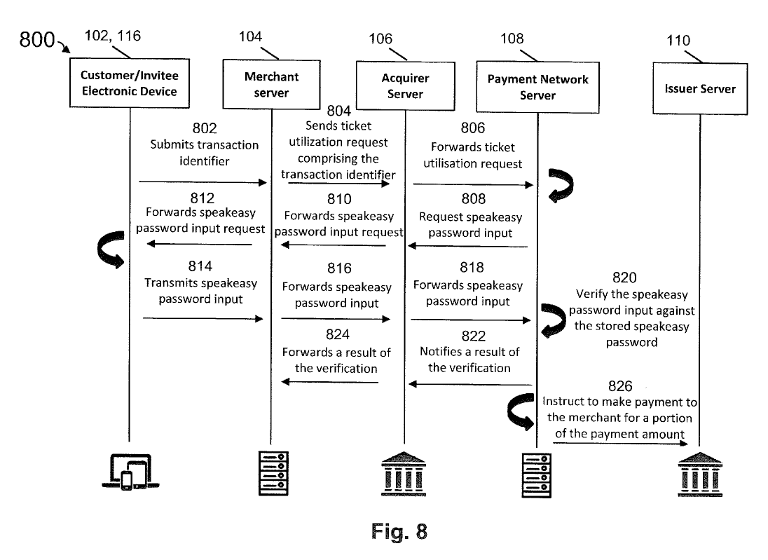

FIG. 8 illustrates an exemplary embodiment for utilising at least one ticket to an event, where the at least one ticket has been purchased or reserved via the payment transaction as described previously in relation to FIG. 7. The at least one ticket may be utilised by the customer and/or the invitee.

To utilise the at least one ticket, the invitee may be required to reproduce the transaction identifier together with its associated speakeasy password at the event. In a step 802, the invitee or the customer may transmit a ticket utilisation request comprising at least the transaction identifier to the merchant server 104 via the invitee electronic device 116 or the customer electronic device 102 respectively. In some embodiments, the transaction identifier is received from the invitee electronic device 116 or the customer electronic device 102 via the merchant apparatus or the POS terminal associated with the merchant server 104. An example of the merchant apparatus may be a self-service kiosk equipped with an input device (e.g. an optical scanner) where the transaction identifier can be read. Upon receiving the transaction identifier, the merchant server 104 is configured to forward the ticket utilisation request to the acquirer server 106 in a step 804 which subsequently transmits the ticket utilisation request to the payment network server 108 in a step 806.

Upon receiving the ticket utilisation request in the step 806, the payment network server 108 is configured to transmit a speakeasy confirmation request comprising a request for a speakeasy password input, to the invitee or the customer. To achieve this, the payment network server 108 is configured to transmit the speakeasy confirmation request to the acquirer server 106 in a step 808, which in turns forwards the speakeasy confirmation request to the merchant server 104 in a step 810. The merchant server 104 is configured to request for a speakeasy password input from the invitee or the customer in a step 812. The speakeasy password input may be received via the invitee electronic device 116 or the customer electronic device 102, or via the merchant apparatus (e.g. an electronic gateway or terminal which prompts the invitee or the customer to input the speakeasy password at an input of the electronic gateway or terminal) associated with the merchant server 104. The input of the electronic gateway or the terminal may include a microphone, a keyboard, a bar code scanner etc. In some embodiments, the speakeasy password input may be given or spoken (e.g. if the speakeasy password is in a form of a speech) to staff associated with the merchant at the event where the staff can enter the speakeasy password input to the merchant server 104.

Upon receiving the speakeasy password input from the invitee or the customer in a step 814, the merchant server 104 is configured to transmit a speakeasy confirmation response comprising at least the speakeasy password input to the acquirer server 106 in a step 816. The speakeasy confirmation response is in turn forwarded by the acquirer server 106 to the payment network server 108 in a step 818. Upon receiving the speakeasy confirmation response from the acquirer server 106, the payment network server 108 is configured to verify the speakeasy password input using the payment network database 114 in a step 820. To verify the speakeasy password input, the payment network server 108 is configured to determine if the speakeasy password input matches the speakeasy password associated with the transaction identifier, which was previously recorded during processing of the payment transaction request (see e.g. the step 724). Utilisation of the ticket is approved if the speakeasy password input is verified.

Once the verification of the speakeasy password input is completed, the payment network server 108 is configured to transmit a ticket utilisation response indicating if utilisation of the ticket is approved or refused to the merchant server 104. This is carried out via steps 822 and 824. In the step 822, the payment network server 108 transmits the ticket utilisation response to the acquirer server 106, which in turns forwards the ticket utilisation response to the merchant server 104 in the step 824. Once the merchant server 104 has received the ticket utilisation response, the merchant server 104 is configured to notify the invitee or the customer if the ticket utilisation request is successful. This may be done either via the merchant apparatus or the POS terminal, or by the staff at the event.

Where the utilisation of the ticket is approved, the payment network server 108 may be configured to instruct the issuer server 110 to transfer at least a portion of the payment amount associated with the cost of the utilised ticket for payment to the merchant In this case, in a step 826, the payment network server 108 is configured to transmit a fund transfer request to transfer at least the portion of the payment amount to the issuer server 110, where the fund transfer request comprises at least the transaction identifier and a transfer amount. The transfer amount is associated with at least a cost of the ticket used by the invitee to participate in the event. In other embodiments (not shown in FIG. 8), the payment network server 108 transmits a request to transfer the portion of the payment amount upon request by the merchant server 104. In this case, the payment network server 108 is configured to receive a fund transfer request comprising a request to transfer at least a portion of the payment amount for the payment transaction from the merchant server 104, and to transmit the fund transfer request to the issuer server 110.

Although it is shown in the present examples of FIGS. 7 and 8 that the merchant server 104 transmits and receives information/data to and fro the payment network server 108 via the acquirer server 106, in some embodiments, the merchant server 104 is able to transmit and receive information/data to and fro the payment network server 108 directly.

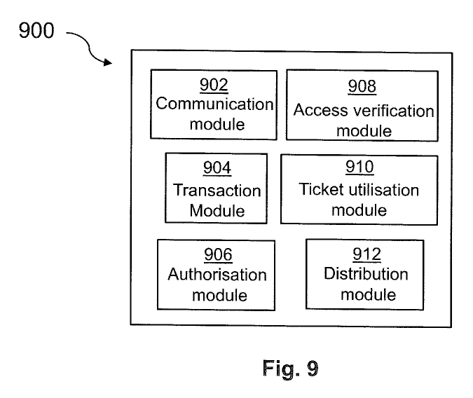

FIG. 9 shows schematically a structure 900 of the payment network server 108 comprised in the computer system 100 in accordance with embodiments of the invention. The structure 900 of the payment network server 108 comprises a communication module 902, a transaction module 904, an authorisation module 906, an access verification module 908, a ticket utilization module 910 and a distribution module 912.

The communication module 902 is configured to enable the payment network server 108 to communicate with at least the acquirer server 106 and the issuer server 110 as provided in the computer system 100. The communication module 902 may be configured to enable the payment network server 108 to communicate with the customer electronic device 102 and the invitee electronic device 116. In some embodiments, the communication module 902 is configured to enable the payment network server 108 to communicate with the merchant server 104 directly. The communication module 902 may be configured to enable the payment network server 108 to communicate with the payment network database 114. The communication module 602 is configured to work in tandem with other modules of the payment network server 108 as discussed in more detail below.

The transaction module 904 is configured to work with the communication module 902 to receive the payment transaction request comprising at least the customer account identifier and the payment amount from the customer electronic device 102, and to transmit the payment transaction response comprising at least the transaction identifier to the customer electronic device 102. In some embodiments where a ticket associated with the transaction identifier has been utilised, the transaction module 904 is configured to transmit a fund transfer request to transfer at least a portion of the payment amount for the payment transaction to the issuer server 110. The fund transfer request comprises at least the transaction identifier and the transfer amount associated with at least the cost of the ticket used by the invitee or the customer to participate in the event. In other embodiments, the fund transfer request is initiated by the merchant server 104. In these cases, where a ticket associated with the transaction identifier is utilised, the transaction module 904 is configured to work with the communication module 902 to receive a fund transfer request comprising a request to transfer at least a portion of the payment amount for the payment transaction from the merchant server 104, and transmit the fund transfer request to transfer at least the portion of the payment amount for the payment transaction to the issuer server 110. In these embodiments, the fund transfer request comprises at least the transaction identifier and the transfer amount. The transaction module 904 may be configured to work with the communication module 902 to receive a fund transfer response indicating whether the fund transfer request is approved or refused from the issuer server 110.

The authorisation module 906 is configured to transmit a request for authorisation to proceed with the payment transaction to the issuer server 110, and to receive an authorisation response indicating if the payment transaction is authorised or refused from the issuer server 110. The request for authorisation comprises at least the customer account identifier and the payment amount. If the payment transaction is authorised by the issuer server 110, the payment amount is blocked in a customer account associated with the customer account identifier.

If the payment transaction request is authorised, the access verification module 908 is configured to work with the communication module 902 to transmit a speakeasy request comprising a request for a speakeasy password to the customer electronic device 102, and to receive a speakeasy response comprising the speakeasy password from the customer electronic device 102. Upon receiving the speakeasy response, the access verification module 908 is configured to generate a transaction identifier associated with the payment transaction, and to store the transaction identifier and the speakeasy password in the payment network database 114 where the speakeasy password is associated with the transaction identifier.

For utilisation of a ticket associated with the transaction identifier, the ticket utilisation module 910 is configured to work with the communication module 902 to: (i) receive, from the invitee electronic device 116 or the customer electronic device 102 and via the merchant server 104, a ticket utilisation request comprising at least the transaction identifier; (ii) transmit a speakeasy confirmation request comprising a request for a speakeasy password input to the invitee electronic device 106; (iii) receive a speakeasy confirmation response comprising at least the speakeasy password input from the invitee electronic device 116; (iv) verify the speakeasy password input using the payment network database 114; and (v) transmit a ticket utilisation response indicating if utilisation of the ticket is approved or refused to the merchant server 104 where the utilisation of the ticket is approved if the speakeasy password input is verified. The speakeasy password input is verified if the speakeasy password input matches the speakeasy password associated with the transaction identifier.

The distribution module 912 is configured to work with the communication module 902 to receive invitee details associated with at least one invitee invited to participate in the event from the customer electronic device 102, and to transmit the transaction identifier and the speakeasy password to each invitee electronic device 116 associated with the at least one invitee using an invitee contact. The invitee details comprises at least the invitee contact, where the invitee contact may be one of a mobile number or an electronic mail address.

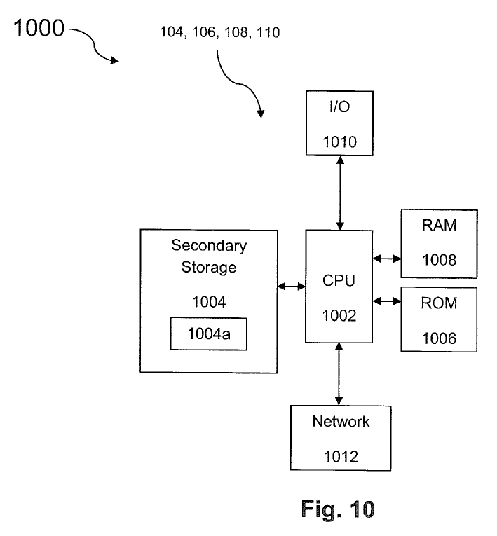

FIG. 10 is a block diagram showing a technical architecture of the payment network server 108. The issuer server 110 and/or the acquirer server 106 may also have this technical architecture. The merchant server 104 may share a similar technical architecture.

The technical architecture includes a processor 1002 (which may be referred to as a central processor unit or CPU) that is in communication with memory devices including secondary storage 1004 (such as disk drives), read only memory (ROM) 1006, and random access memory (RAM) 1008. The processor 1002 may be implemented as one or more CPU chips. The technical architecture may further comprise input/output (I/O) devices 1010, and system connectivity or network devices 1012.

The secondary storage 1004 is typically comprised of one or more disk drives or tape drives and is used for non-volatile storage of data and as an over-flow data storage device if RAM 1008 is not large enough to hold all working data. Secondary storage 1004 may be used to store programs which are loaded into RAM 1008 when such programs are selected for execution.

In some embodiments, the secondary storage 1004 has a processing component 1004a comprising non-transitory instructions operative by the processor 1002 to perform various operations of the method of the present disclosure. The ROM 1006 is used to store instructions and perhaps data which are read during program execution. The secondary storage 1004, the ROM 1006, and/or the RAM 1008 may be referred to in some contexts as computer readable storage media and/or non-transitory computer readable media.

I/O devices 1010 may include printers, video monitors, liquid crystal displays (LCDs), plasma displays, touch screen displays, keyboards, keypads, switches, dials, mice, track balls, voice recognizers, card readers, paper tape readers, or other input devices.

The system connectivity or network devices 1012 may take the form of modems, modem banks, Ethernet cards, universal serial bus (USB) interface cards, serial interfaces, token ring cards, fiber distributed data interface (FDDI) cards, wireless local area system (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other system devices. These system connectivity or network devices 1012 may enable the processor 1002 to communicate with the Internet or one or more intranets. With such a system connection, it is contemplated that the processor 1002 might receive information from the system, or might output information to the system in the course of performing the above-described method operations. Such information, which is often represented as a sequence of instructions to be executed using processor 1002, may be received from and outputted to the system, for example, in the form of a computer data signal embodied in a carrier wave.

The processor 1002 executes instructions, codes, computer programs, scripts which it accesses from hard disk, floppy disk, optical disk (these various disk based systems may all be considered secondary storage 1004), flash drive, ROM 1006, RAM 1008, or the system connectivity or network devices 1012. While only one processor 1002 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing an application and/or applications in a cloud computing environment. Cloud computing may comprise providing computing services via a system connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 1002, the ROM 1006, and the RAM 1008 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

1. A payment network server for processing a payment transaction for at least one ticket to an event, the payment network server comprising:
a transaction module configured to:
receive, from a customer electronic device, a payment transaction request comprising at least a customer account identifier and a payment amount; and
transmit, to the customer electronic device, a payment transaction response comprising at least the transaction identifier;
an authorisation module configured to:
transmit, to an issuer server, a request for authorisation to proceed with the payment transaction, wherein the request for authorisation comprises at least the customer account identifier and the payment amount, and wherein the payment amount is blocked in a customer account associated with the customer account identifier if the payment transaction is authorised; and
receive, from the issuer server, an authorisation response indicating if the payment transaction is authorised or refused; and
an access verification module configured to:
transmit, to the customer electronic device, a speakeasy request comprising a request for a speakeasy password if the payment transaction is authorised;
receive, from the customer electronic device, a speakeasy response comprising the speakeasy password;
generate a transaction identifier, the transaction identifier being associated with the payment transaction; and
store, using a payment network database, the transaction identifier and the speakeasy password, wherein the speakeasy password is associated with the transaction identifier.

2. The server of claim 1 further comprising:
a ticket utilisation module configured to:
receive, from an invitee electronic device via a merchant server, a ticket utilisation request comprising at least the transaction identifier;
transmit, to the invitee electronic device, a speakeasy confirmation request comprising a request for a speakeasy password input;
receive, from the invitee electronic device, a speakeasy confirmation response comprising at least the speakeasy password input;
verify, using the payment network database, the speakeasy password input, the speakeasy password input is verified if the speakeasy password input matches the speakeasy password associated with the transaction identifier; and
transmit, to the merchant server, a ticket utilisation response indicating if utilisation of the ticket is approved or refused, the utilisation of the ticket is approved if the speakeasy password input is verified.

3. The server of claim 2, wherein when the ticket is utilised by the invitee, the transaction module is further configured to:
transmit, to the issuer server, a fund transfer request to transfer at least a portion of the payment amount for the payment transaction, the fund transfer request comprising at least the transaction identifier and a transfer amount, the transfer amount being associated with at least a cost of the ticket used by the invitee to participate in the event; and
receive, from the issuer server, a fund transfer response indicating whether the fund transfer request is approved or refused.

4. The server of claim 2, wherein when the ticket is utilised by the invitee, the transaction module is further configured to:
receive, from the merchant server, a fund transfer request comprising a request to transfer at least a portion of the payment amount for the payment transaction, the fund transfer request comprising at least the transaction identifier and a transfer amount, the transfer amount being associated with at least a cost of the ticket used by the invitee to participate in the event;
transmit, to the issuer server, the fund transfer request to transfer at least the transfer amount; and
receive, from the issuer server, a fund transfer response indicating whether the fund transfer request is approved or refused.

5. The server of claim 1 further comprising:
a distribution module configured to:
receive, from the customer electronic device, invitee details associated with at least one invitee invited to participate in the event, the invitee details comprising at least an invitee contact; and
transmit, to each invitee electronic device associated with the at least one invitee using the invitee contact, the transaction identifier and the speakeasy password.

6. The server of claim 5, wherein the invitee contact is one of a mobile number or an electronic mail address.

7. The server of claim 1, wherein the speakeasy password comprises a string of numbers, symbols or alphanumeric characters.

8. The server of claim 1, wherein the speakeasy password received via the customer electronic device is in the form of a speech.

9. The server of claim 1, wherein the transaction identifier is one of the following: a Quick Response (QR) code, a barcode, an EZcode, a high capacity color barcode, a ShotCode, a MaxiCode, a GTIN12 code, a GTIN-13 code, an Aztec code, a name and a mobile number.

10. A computer-implemented method for processing a payment transaction for at least one ticket to an event, the method comprising:
receiving, from a customer electronic device, a payment transaction request comprising at least a customer account identifier and a payment amount;
transmitting, to an issuer server, a request for authorisation to proceed with the payment transaction, wherein the request for authorisation comprises at least the customer account identifier and the payment amount, and wherein the payment amount is blocked in a customer account associated with the customer account identifier if the payment transaction is authorised;
receiving, from the issuer server, an authorisation response indicating if the payment transaction is authorised or refused;
transmitting, to the customer electronic device, a speakeasy request comprising a request for a speakeasy password if the payment transaction is authorised;
receiving, from the customer electronic device, a speakeasy response comprising the speakeasy password;
generating a transaction identifier, the transaction identifier being associated with the payment transaction;
storing, using a payment network database, the transaction identifier and the speakeasy password, wherein the speakeasy password is associated with the transaction identifier; and
transmitting, to the customer electronic device, a payment transaction response comprising at least the transaction identifier.

11. The method of claim 10 further comprising:
receiving, from an invitee electronic device via a merchant server, a ticket utilisation request comprising at least the transaction identifier;
transmitting, to the invitee electronic device, a speakeasy confirmation request comprising a request for a speakeasy password input;
receiving, from the invitee electronic device, a speakeasy confirmation response comprising at least the speakeasy password input;
verifying, using the payment network database, the speakeasy password input, the speakeasy password input is verified if the speakeasy password input matches the speakeasy password associated with the transaction identifier; and
transmitting, to the merchant server, a ticket utilisation response indicating if utilisation of the ticket is approved or refused, the utilisation of the ticket is approved if the speakeasy password input is verified.

12. The method of claim 11, wherein when the ticket is utilised by the invitee, the method further comprises:
transmitting, to the issuer server, a fund transfer request to transfer at least a portion of the payment amount for the payment transaction, the fund transfer request comprising at least the transaction identifier and a transfer amount, the transfer amount being associated with at least a cost of the ticket used by the invitee to participate in the event; and
receiving, from the issuer server, a fund transfer response indicating whether the fund transfer request is approved or refused.

13. The method of claim 11, wherein when the ticket is utilised by the invitee, the method further comprises:
receiving, from the merchant server, a fund transfer request comprising a request to transfer at least a portion of the payment amount for the payment transaction, the fund transfer request comprising at least the transaction identifier and a transfer amount, the transfer amount being associated with at least a cost of the ticket used by the invitee to participate in the event;
transmitting, to the issuer server, the fund transfer request to transfer at least the portion of the payment amount; and
receiving, from the issuer server, a fund transfer response indicating whether the fund transfer request is approved or refused.

14. The method of claim 10 further comprising:
receiving, from the customer electronic device, invitee details associated with at least one invitee invited to participate in the event, the invitee details comprising at least an invitee contact; and
transmitting, to each invitee electronic device associated with the at least one invitee using the invitee contact, the transaction identifier and the speakeasy password.

15. The method of claim 14, wherein the invitee contact is one of a mobile number or an electronic mail address.

16. The method of claim 10, wherein the speakeasy password is-comprises a string of numbers, words, symbols or alphanumeric characters.

17. The method of claim 10, wherein the speakeasy password received via the customer electronic device is in the form of a speech.

18. The method of claim 10, wherein the transaction identifier is one of the following: a Quick Response (QR) code, a barcode, an EZcode, a high capacity color barcode, a ShotCode, a MaxiCode, a GTIN12 code, a GTIN-13 code, Aztec code, a name and a mobile number.

19. A non-transitory computer-readable medium having stored thereon program instructions for causing at least one processor to:
receive, from a customer electronic device, a payment transaction request comprising at least a customer account identifier and a payment amount;
transmit, to an issuer server, a request for authorisation to proceed with the payment transaction, wherein the request for authorisation comprises at least the customer account identifier and the payment amount, and wherein the payment amount is blocked in a customer account associated with the customer account identifier if the payment transaction is authorised;
receive, from the issuer server, an authorisation response indicating if the payment transaction is authorised or refused;
transmit, to the customer electronic device, a speakeasy request comprising a request for a speakeasy password if the payment transaction is authorised;
receive, from the customer electronic device, a speakeasy response comprising the speakeasy password;
generate a transaction identifier, the transaction identifier being associated with the payment transaction;
store, using a payment network database, the transaction identifier and the speakeasy password, wherein the speakeasy password is associated with the transaction identifier; and
transmit, to the customer electronic device, a payment transaction response comprising at least the transaction identifier.
